(19) United States
(12) Patent Application Publication
(10) Pub. No.: US 2018/0207869 A1
(43) Pub. Date: Jul. 26, 2018

(54) APPARATUS FOR DRIVING FILAMENT SPOOL OF 3D PRINTER

(71) Applicant: SINDOH CO., LTD., Seoul (KR)

(72) Inventors: Byoung-bag LEE, Seoul (KR); Jae-han PARK, Seoul (KR); Kyu-hoon HAN, Seoul (KR)

(21) Appl. No.: 15/876,489

(22) Filed: Jan. 22, 2018

(30) Foreign Application Priority Data
Jan. 23, 2017 (KR) 10-2017-0010218

(51) Int. Cl. B29C 64/241; B29C 64/209; B29C 64/218; B29C 31/04

(52) U.S. Cl. CPC B29C 64/241; B29C 64/209; B29C 64/118; B29C 31/042; B29C 64/218

(57) ABSTRACT

The present invention provides an apparatus for driving a filament spool of a 3D printer, which rotates the filament spool for wounding a wire-shaped filament in a forward or reverse direction, including a driving motor installed between an extruder for discharging the filament wound on the filament spool toward a hot end nozzle side and the filament spool and configured to generate a driving force in the forward or reverse direction; a feed roller configured to receive the driving force of the driving motor and to transfer the filament wound on the filament spool to an extruder side or to wound back the filament of the extruder on the filament spool; a filament spool driving roller installed between the feed roller and the filament spool and configured to receive the driving force of the driving motor and to rotate the filament spool; and a torque limiter installed between the driving motor and the feed roller and configured to cause a gear on a filament spool side to idle and only a gear on a driving motor side to rotate when a filament transferring force on the filament spool side is larger than the driving force on the driving motor side.

### BACKGROUND OF THE INVENTION

### Field of the Invention

The present disclosure relates to an apparatus for driving a filament spool of a 3D printer.

### Description of the Prior Art

In order to manufacture a prototype product having a three-dimensional shape, a method of manually manufacturing a mock-up according to drawings and a manufacturing method by CNC milling are widely known.

However, since the method of manufacturing the mock-up is performed by hand, it is difficult to perform accurate numerical control and it takes a lot of time, and in the case of the manufacturing method by CNC milling, it is possible to perform the accurate numerical control, but many shapes are difficult to machine due to tool interference.

Therefore, there has been recently proposed a so-called three-dimensional printing method in which three-dimensional modeling data is generated using CAD or CAM and a three-dimensional prototype product is manufactured using the generated data, and these 3D printers are used in various fields such as industry, life, and medicine.

A 3D printer is a manufacturing apparatus which manufactures objects by outputting successive layers of materials like a two-dimensional printer and stacking the layers. The 3D printer can manufacture objects quickly based on digitized drawing information and thus is mainly used to manufacture prototype samples.

A product forming method of the 3D printer includes a forming method in which a photocurable material is irradiated with a laser beam and the irradiated portion is formed into an object, a forming method (FDM method) in which thermoplastic filaments are melted and stacked, and so on.

Among these methods, a 3D printer in which the filaments are melted and stacked has lower production cost than other types of 3D printers, and thus the 3D printer using the filament is becoming popular for home and industrial use.

Korean Patent No. 10-1645250 discloses a filament supply/discharge device for a 3D printer. The 3D printer disclosed in the patent document is an FDM type three-dimensional printer in which filaments are melted and stacked and includes a filament supply unit which winds a wire-shaped filament and supplies the wound filament; a filament output unit which outputs a 3D printed matter by melting and discharging the filament supplied from the filament supply unit; and a driving unit which automatically supplies the filaments from the filament supply unit to the filament output unit and automatically discharges the filaments from the filament output unit toward the filament supply unit.

Here, the filament supply unit includes a filament spool which winds the filament, and the filament driving unit includes a motor, a gear and a roller which supply the filament wound on the spool toward a filament output unit side or which winds the filament of the filament output portion back on the spool.

However, a feed roller of the filament driving unit has a constant line speed, but a line speed of the filament wound on the spool changes according to a wound amount. For example, when the amount of filament wound on the spool is large, the line speed thereof increases due to a relatively large rotating radius, and when the amount of filament wound on the spool is small, the line speed thereof decreases due to a relatively small rotating radius. When a difference between the line speeds of the feed roller and the spool increases to some extent according to the change of the line speed in the spool, a gear locking phenomenon occurs in which a gear of the filament driving unit is locked and is not operated.

### SUMMARY OF THE INVENTION

The present invention has been made in order to solve the above problems, and an object thereof is to provide an apparatus for driving a filament spool of a 3D printer, which is capable of preventing a gear locking phenomenon in which a gear is locked according to an amount of filament wound on the spool and is not operated.

To achieve the object, the present invention provides an apparatus for driving a filament spool of a 3D printer, which rotates the filament spool for wounding a wire-shaped filament in a forward or reverse direction, including a driving motor installed between an extruder for discharging the filament wound on the filament spool toward a hot end nozzle side and the filament spool and configured to generate a driving force in a forward or reverse direction; a feed roller configured to receive the driving force of the driving motor and to transfer the filament wound on the filament spool to an extruder side or to wound back the filament of the extruder on the filament spool; a filament spool driving roller installed between the feed roller and the filament spool and configured to receive the driving force of the driving motor and to rotate the filament spool; and a torque limiter installed between the driving motor and the feed roller and configured to cause a gear on a filament spool side to idle and only a gear on a driving motor side to rotate when a filament transferring force on the filament spool side is larger than the driving force on the driving motor side.

Preferably, the apparatus may further include an extruder roller installed at extruder and configured to transfer the filament from the filament spool to the extruder, and the driving motor may transmit the driving force to the extruder roller and the feed roller.

Additionally, the apparatus may include a clutch installed between the driving motor and the feed roller and configured to selectively transmit the driving force of the driving motor to the feed roller.

Further, the filament spool may is built in a case having a filament discharge port at one side thereof, the feed roller and the filament spool driving roller may be disposed on a side opposite to the discharge port, an entrance port of the extruder may be disposed on a discharge port side of the case, and transmission gears configured to transmit the driving force of the driving motor to the extruder roller and the feed roller, the driving motor and the torque limiter may be disposed between the discharge port of the case and the feed roller.

Preferably, the torque limiter may include a first gear connected to the transmission gear on a driving motor side and a second gear connected to the transmission gear on a filament spool side, a limiter supported by a spring may be installed between the first gear and the second gear, and the second gear may idle when a difference between a force transmitted to a first gear side and a force transmitted to a second gear side exceeds the elastic force of the spring.

Meanwhile, the filament spool may have a gear-shaped portion at an outer circumference, and the filament spool driving roller may have a gear-shaped portion which is engaged with the gear-shaped portion of the filament spool.

Further, the feed roller and the filament spool driving roller may have gear-shaped portions which are engaged with each other.

Preferably, the apparatus may further include two driving gears disposed coaxially with the feed roller, and one of the driving gears may drive the feed roller, and the other gear may be connected to the filament spool driving roller to drive the spool.

According to the present invention, the gear locking phenomenon in which the gear is locked and is not operated can be prevented by adjusting a rotational speed of the feed roller in accordance with a change in a filament pulling force depending on an amount of filament wound on the filament spool.

Further, according to the present invention, it is possible to drive both the extruder roller and the feed roller using one drive motor, and it is possible to secure a short driving distance by concentrating the driving components on one side of the case. Therefore, the driving unit of the 3D printer can be configured compactly.

### BRIEF DESCRIPTION OF THE DRAWINGS

FIG. 1 is a perspective view showing an apparatus for driving a filament spool of a 3D printer according to the present invention;

FIG. 2 is a perspective view of the apparatus for driving the filament spool of the 3D printer according to the present invention when seen in another direction;

FIG. 3 is a front view of the apparatus for driving the filament spool of the 3D printer according to the present invention;

FIG. 4 is a front view of the apparatus for driving the filament spool of the 3D printer according to the present invention, which shows a state in which a filament is wound back; and

FIG. 5 is a cross-sectional view showing a torque limiter of the apparatus for driving the filament spool of the 3D printer according to the present invention.

### DETAILED DESCRIPTION OF THE EXEMPLARY EMBODIMENTS

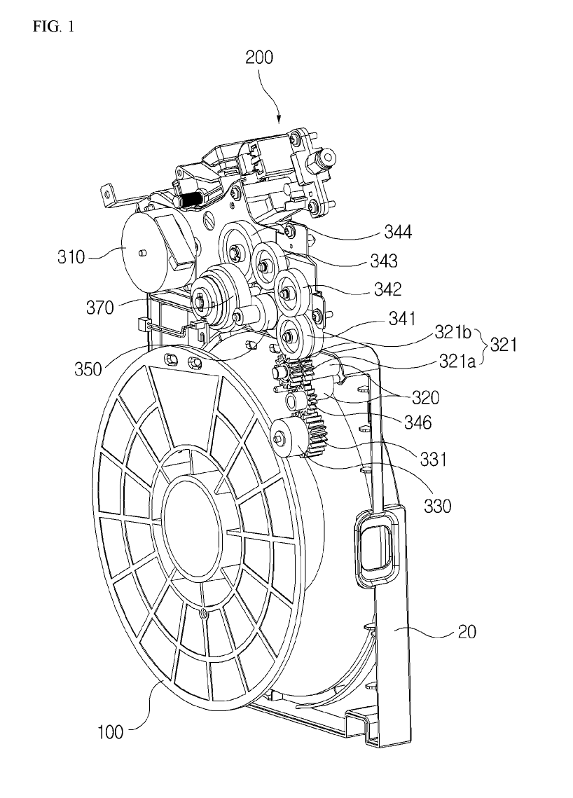

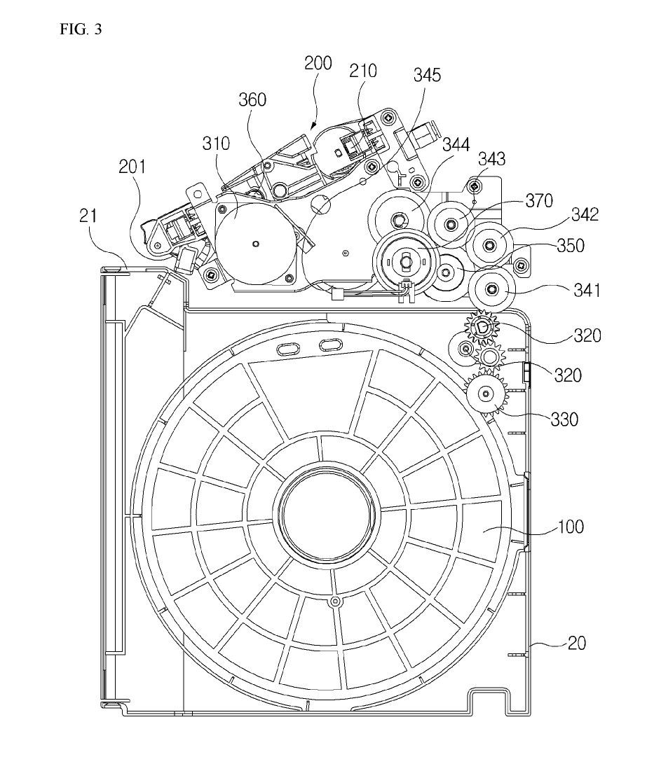

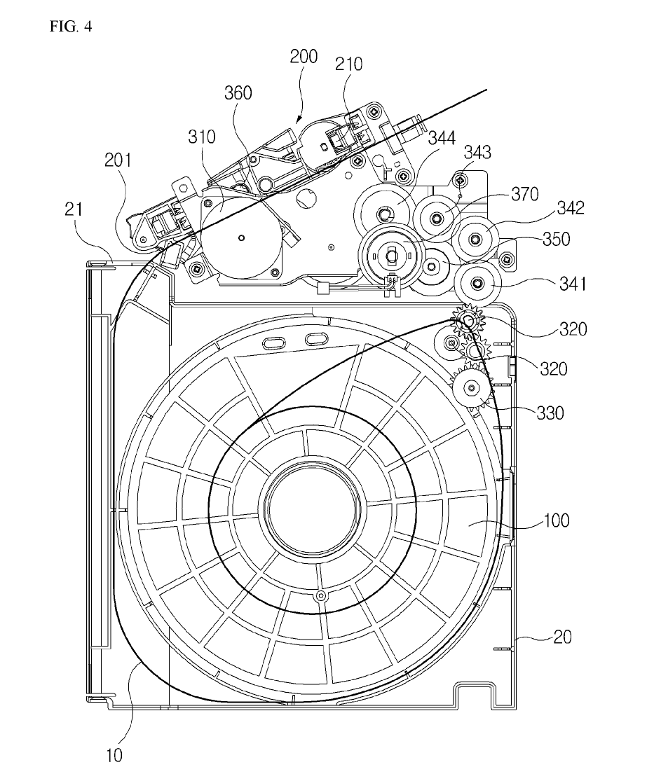

Referring to FIGS. 1 to 4, an apparatus for driving a filament spool of a 3D printer according to the present invention is an apparatus in which a filament spool 100 for winding a wire-shaped filament 10 is rotated in a reverse direction to transfer the filament from the filament spool 100 to an extruder 200 side or from the extruder 200 to the filament spool 100 side.

First, the apparatus for driving the filament spool of the 3D printer according to the present invention is built in a main body (not shown) of the 3D printer together with the filament spool 100 for winding the filament and the extruder 200 for discharging the filament of the filament spool 100 to a hot end nozzle (not shown) side.

The apparatus for driving the filament spool of the 3D printer according to the present invention includes a driving motor 310, a feed roller 320, a filament spool driving roller 330, transmission gears 341 to 345, and a torque limiter 350.

The driving motor 310 is installed between the extruder 200 and the filament spool 100, generates a driving force in a forward or reverse direction and rotates the feed roller 320 and an extruder roller 360, which will be described later, in a forward or reverse direction.

The feeding roller 320 is installed on a side opposite to a discharge port 21 of a case 20 in which the filament spool 100 is built and serves to receive the driving force of the driving motor 310 and to transfer the filament wound on the filament spool 100 to the extruder 200 side or to wind the filament of the extruder 200 back on the filament spool 100.

The extruder roller 360 is installed at one side of the extruder 200 to allow the filament to be transferred from the filament spool 100 to the extruder 360. The extruder roller 360 is driven by the driving motor 310.

The filament spool driving roller 330 is installed between the feed roller 320 and the filament spool 100 inside the case 20 to receive the driving motor 310, thereby rotating the filament spool 100.

The transmission gears 341 to 345 are installed between the driving motor 310 and the feed roller 320 and between the driving motor 310 and the extruder 360 to transmit the driving force of the driving motor 310 to the feed roller 320 and the extruder 360.

The torque limiter 350 is installed between the driving motor 319 and the feed roller 320 outside the case 20 so that a gear of the filament spool 100 idles and only the gear on the driving motor 310 side rotates when a filament conveying force on the filament spool 100 side becomes larger than the driving force on the driving motor 310 side. For example, when the driving motor 310 is driven in a state in which a large amount of filament is wound on the filament spool 100, the feed roller 320 and the filament spool 100 are rotated at a constant speed by the driving force of the driving motor 310, but the force by which the filament spool 100 pulls the filament exceeds the rotational speed of the feed roller 320. At this time, the torque limiter 350 causes the transmission gear 341 provided between the torque limiter 350 and the feed roller 320 to idle and thus allows the filament to be transferred in accordance with the rotational speed of the feed roller 320 and the exciter roller 360.

As described above, in the apparatus for driving the filament spool of the 3D printer according to the present invention, a gear locking phenomenon in which a gear is locked and is not operated can be prevented by adjusting the rotational speed of the feed roller 320 in accordance with a change in the force by which the filament spool 100 pulls the filament depending on the amount of filament wound on the filament spool 100.

Additionally, the apparatus for driving the filament spool of the 3D printer according to the present invention includes a clutch 370 which is installed between the driving motor 310 and the feed roller 320 to selectively transmit the driving force of the driving motor 310 to the feed roller 320.

The clutch 370 may be a one-way clutch or an electromagnetic clutch which transmits power only in one direction due to a mechanical shape. And the extruder 200 may include a detection sensor 210 which detects the filament.

Here, when the driving motor 310 is driven in a forward direction, the clutch 370 is controlled to be in an ON state until detecting sensor 210 detects the filament. Therefore, the driving force of the driving motor 310 is transmitted to the extruder roller 360 and the feed roller 320, and the filament is transferred from the filament spool 100 toward the extruder 200. After the detecting sensor 210 detects the filament, the clutch 370 is controlled to be in an OFF state. Therefore, the driving force of the driving motor 310 is transmitted only to the extruder roller 360.

On the other hand, when the driving motor 310 is driven in a reverse direction, the clutch 370 is controlled to be always in an ON state. Therefore, when the driving motor 310 is driven in a reverse direction, the driving force is transmitted to both the extruder roller 360 and the feed roller 320.

Due to such operation controlling of the clutch 370, when the filament is supplied in a forward direction, initially, the extruder roller 360 and the feed roller 320 can be simultaneously operated to output the filament with a relatively large force, and then only the extruder roller 360 can be operated to smoothly output the filament. And when the filament is discharged in a reverse direction, the extruder roller 360 and the feed roller 320 can be always operated at the same time to pull the filament with a relatively large force. That is, the apparatus for driving the filament spool of the 3D printer according to the present invention can control a transferring speed of the filament using the clutch 370 which selectively drives the feed roller 320.

Meanwhile, the filament spool 100 is built in the case 20 having the filament discharge port 21 on one side thereof, and the feed roller 320 and the filament spool driving roller 330 are disposed on a side opposite to the discharge port 21. Also, an entrance port 201 of the extruder 200 is disposed on the discharge port 21 side of the case 20, and the transmission gears 341 to 345, the driving motor 310, the clutch 370 and the torque limiter 350 are disposed between the discharge port 21 of the case 20 and the feed roller 320 outside the case 20.

Due to such an arrangement of the elements, the present invention can drive all of the extruder roller 360 and the feed roller 320 using one driving motor 310, and the driving components are concentrated on one side of the case 20, thereby ensuring a short driving distance. Therefore, a driving unit of the 3D printer can be configured compactly.

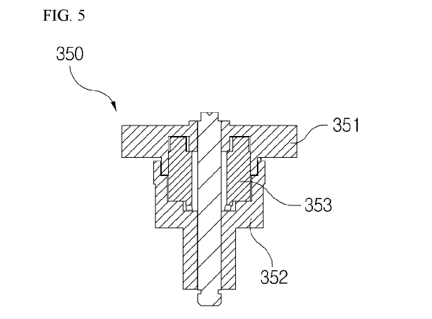

Meanwhile, referring to FIG. 5, the above-described torque limiter 350 includes a first gear 351 which is connected to the transmission gear 343 on the driving motor 310 side and a second gear 352 which is connected to the transmission gear 341 on the filament spool 100 side, and a limiter 353 supported by a spring (not shown) is installed between the first gear 351 and the second gear 352. The torque limiter 350 is configured so that the second gear 352 idles, that is, an engagement between the first gear 351 and the second gear 352 is released and the driving force of the first gear 351 is not transmitted to the second gear 352 when a difference between a force transmitted to the first gear 351 side and a force transmitted to the second gear 352 side exceeds an elastic force of the spring.

Therefore, when a relatively large amount of filament is wound on the filament spool 100, the force by which the filament spool 100 pulls the filament increases, and a force transmitted to the second gear 352 of the torque limiter 350 exceeds the force of the spring, and thus the second gear 352 idles. Accordingly, the rotational speed of the feed roller 320 can be adjusted in accordance with the driving force of the driving motor 310.

Preferably, the filament spool 100 may have a gear-shaped portion (not shown) on an outer circumference thereof, and the filament spool driving roller 330 may have a gear-shaped portion (not shown) which is engaged with the gear-shaped portion of the filament spool 100. Therefore, the driving force of the driving motor 310 can be accurately transmitted to the filament spool 100.

Also, the feed roller 320 and the filament spool driving roller 330 may respectively have gear-shaped portions 321 and 331 which are engaged with each other at one side of each of them (actually, a separate connection gear 346 is installed between the feed roller 320 and the filament spool driving roller 330). The transmission gears 341 to 345 are connected to the gear-shaped portion 321 of the feed roller 320 to transmit the driving force of the driving motor 310 to the feed roller 320, and the gear-shaped portion 321 of the feed roller 320 is connected to the gear-shaped portion 331 of the filament spool driving roller 330 to transmit the driving force of the driving motor 310 to the filament spool 100.

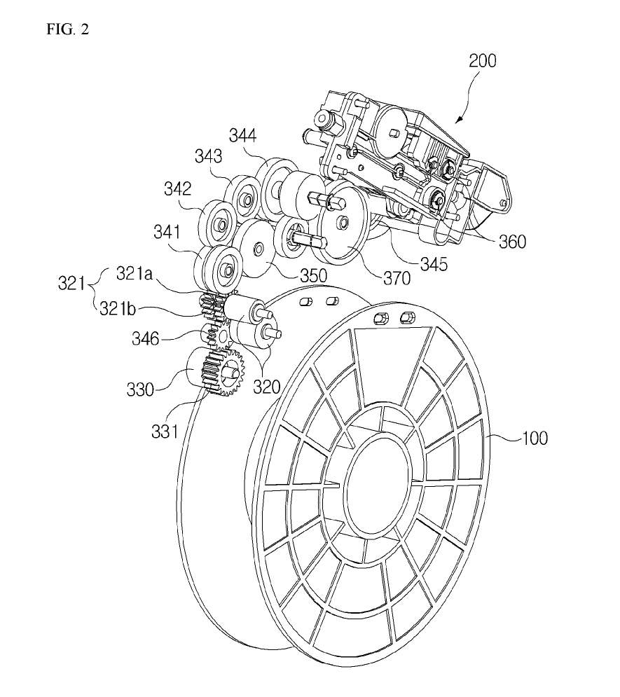

Referring to FIGS. 1 and 2 again, preferably, in the apparatus for driving the filament spool of the 3D printer according to the present invention, a gear train for driving the feed roller 320 and a gear train for driving the filament spool 100 are separated from each other.

Specifically, the feed roller 320 is provided with two driving gears 321a and 321b disposed coaxially with the feed roller 320, and one 321a of the driving gears 321a and 321b is used for driving the feed roller 320, and the other one 321b thereof is connected to the filament spool driving gear 330, more precisely, the connection gear 346 and is used to drive the filament spool 100. Therefore, upon the rotation in a reverse direction, the moving speed of the filament due to the rotation of the filament spool 100 can be made faster than the transferring speed of the filament of the feed roller 320.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An apparatus for driving a filament spool of a 3D printer, which rotates the filament spool for wounding a wire-shaped filament in a forward or reverse direction, comprising
a driving motor installed between an extruder for discharging the filament wound on the filament spool toward a hot end nozzle side and the filament spool and configured to generate a driving force in a forward or reverse direction;
a feed roller configured to receive the driving force of the driving motor and to transfer the filament wound on the filament spool to an extruder side or to wound back the filament of the extruder on the filament spool;
a filament spool driving roller installed between the feed roller and the filament spool and configured to receive the driving force of the driving motor and to rotate the filament spool; and
a torque limiter installed between the driving motor and the feed roller and configured to cause a gear on a filament spool side to idle and only a gear on a driving motor side to rotate when a filament transferring force on the filament spool side is larger than the driving force on the driving motor side.

2. The apparatus according to claim 1, further comprising an extruder roller installed at extruder and configured to transfer the filament from the filament spool to the extruder,
wherein the driving motor transmits the driving force to the extruder roller and the feed roller.

3. The apparatus according to claim 2, comprising a clutch installed between the driving motor and the feed roller and configured to selectively transmit the driving force of the driving motor to the feed roller.

4. The apparatus according to claim 2, wherein the filament spool is built in a case having a filament discharge port at one side thereof,
the feed roller and the filament spool driving roller are disposed on a side opposite to the discharge port,
an entrance port of the extruder is disposed on a discharge port side of the case, and
transmission gears configured to transmit the driving force of the driving motor to the extruder roller and the feed roller, the driving motor and the torque limiter are disposed between the discharge port of the case and the feed roller.

5. The apparatus according to claim 4, wherein the torque limiter includes a first gear connected to the transmission gear on a driving motor side and a second gear connected to the transmission gear on a filament spool side,
a limiter supported by a spring is installed between the first gear and the second gear, and
the second gear idles when a difference between a force transmitted to a first gear side and a force transmitted to a second gear side exceeds the elastic force of the spring.

6. The apparatus according to claim 1, wherein the filament spool has a gear-shaped portion at an outer circumference, and the filament spool driving roller has a gear-shaped portion which is engaged with the gear-shaped portion of the filament spool.

7. The apparatus according to claim 1, wherein the feed roller and the filament spool driving roller have gear-shaped portions which are engaged with each other.

8. The apparatus according to claim 1, further comprising two driving gears disposed coaxially with the feed roller,
wherein one of the driving gears drives the feed roller, and the other gear is connected to the filament spool driving roller to drive the spool.
